(19) United States
(12) Patent Application Publication
(10) Pub. No.: US 2017/0083063 A1
(43) Pub. Date: Mar. 23, 2017

(54) CIRCUITS AND METHODS PROVIDING TEMPERATURE MITIGATION FOR COMPUTING DEVICES USING IN-PACKAGE SENSOR

(71) Applicant: QUALCOMM Incorporated, San Diego, CA (US)

(72) Inventors: Mehdi Saeidi, San Diego, CA (US); Melika Roshandell, Carlsbad, CA (US); Arpit Mittal, San Diego, CA (US); Farsheed Mahmoudi, San Diego, CA (US)

(21) Appl. No.: 14/860,127

(22) Filed: Sep. 21, 2015

(51) Int. Cl. G06F 1/20; G01K 7/22

(52) U.S. Cl. CPC G06F 1/206; G01K 7/22

(57) ABSTRACT

A method includes: receiving an electrical signal from a temperature sensor, wherein the temperature sensor is disposed within a package including a processor chip, further wherein the temperature sensor is thermally separated from the processor chip by materials within the package, generating temperature information from the electrical signal, processing the temperature information to determine that a performance of the processor chip should be mitigate, and mitigating the performance of the processor chip in response to the temperature information, wherein processing the temperature information and mitigating the performance of the processor are performed by the processor chip.

### TECHNICAL FIELD

This application relates to thermal mitigation and, more specifically, to providing thermal mitigation to a computing device using an in-package and off-chip temperature sensor.

### BACKGROUND

A conventional modern smart phone may include a system on chip (SOC), which has a processor and other operational circuits. Specifically, an SOC in a smart phone may include a processor chip within a package, where the package is mounted on a printed circuit board (PCB) internally to the phone. The phone includes an external housing and a display, such as a liquid crystal display (LCD). A human user when using the phone physically touches the external housing and the display.

As the SOC operates, it generates heat. In one example, the SOC within a smart phone may reach temperatures of 80° C.-100° C. Furthermore, conventional smart phones do not include fans to dissipate heat. During use, such as when a human user is watching a video on a smart phone, the SOC generates heat, and the heat is spread through the internal portions of the phone to the outside surface of the phone.

The outside surface of the phone is sometimes referred to as the “skin.” The outside surface includes the part of the external housing that is physically on the outside of the phone as well as any other externally-exposed portions, such as an LCD display. It is generally accepted that the skin of the phone should not reach temperatures higher than about 40° C.-45° C. due to safety and ergonomic reasons. As noted above, the SOC within the smart phone may reach temperatures of 80° C.-100° C., although the temperature of the SOC is not felt directly at the skin of the phone. Instead, heat dissipation within the phone often means that the skin temperature of the phone is at a lower temperature than the SOC temperature. Furthermore, whereas changes to SOC temperature may be relatively quick (e.g., seconds), changes to device skin temperature may be relatively slow (e.g., tens of seconds or minutes).

Conventional smart phones include algorithms to control the skin temperature by reducing a frequency of operation of the SOC when a temperature sensor in the SOC reaches a threshold level. However, SOC temperature can be a poor proxy for device skin temperature.

### SUMMARY

Various embodiments include systems and methods that mitigate temperature by measuring temperature off-chip and in-package and reducing performance of a processor, if appropriate, based at least in part on the temperature measurement.

In one embodiment, a method includes receiving an electrical signal from a temperature sensor, wherein the temperature sensor is disposed within a package including a processor chip, further wherein the temperature sensor is thermally separated from the processor chip by materials within the package, generating temperature information from the electrical signal, processing the temperature information to determine that a performance of the processor chip should be mitigated, and mitigating the performance of the processor chip in response to the temperature information, wherein processing the temperature information and mitigating the performance of the processor are performed by the processor chip.

In another embodiment, a system includes a computer processor configured to execute machine-readable instructions and to consume power from a system battery, the computer processor being disposed within a package having a dielectric substrate and providing electrical communication between the computer processor and a plurality of electrical components of the system, a physical housing enclosing at least a portion of the system, the package being disposed within the system so that it is enclosed within the physical housing, the computer processor further being in thermal contact with the physical housing through the package, and a temperature measuring device disposed within the package and thermally separated from the computer processor by materials of the package, the temperature measuring device being in electrical communication with the computer processor. The computer processor is configured to perform the following operation: receive electrical signals from the temperature measuring device, in response to the electrical signals from the temperature measuring device, determine that a thermal mitigation operation should be undertaken, and reduce an operating parameter of the computer processor in accordance with the thermal mitigation operation.

In another embodiment, a system includes means for providing information indicating a temperature of a chip package within the system, means for comparing the temperature of the chip package to a temperature threshold and for generating a control signal in response to determining that the temperature of the chip package exceeds the temperature threshold, means for reducing an operating parameter of the means for comparing in response to the control signal; and a physical housing enclosing at least the means for comparing and the means for providing, the means for comparing further being in thermal contact with the means for providing through a substrate of the chip package.

In yet another embodiment, a computer program product having a computer readable medium tangibly recording computer program logic for mitigating temperature of a chip, the computer program product includes code to generate temperature information from a sensor within a chip package and at a location physically separate from the chip within the chip package, code to compare the temperature information to a programmed temperature threshold, wherein comparing the temperature information to the programmed temperature threshold is performed by the chip, code to reduce an operating parameter of the chip in response to comparing the temperature information to the programmed temperature threshold, and code to increase the operating parameter of the chip in response to determining that the temperature information indicates a reduction in temperature.

### BRIEF DESCRIPTION OF THE DRAWINGS

FIG. 1 is an illustration of an example computing device that may perform a method according to various embodiments.

FIG. 2 is an illustration of the internal functional units of the computing device of FIG. 1, according to one embodiment.

FIG. 3 is an illustration of thermal management circuitry and logic, according to one embodiment.

FIG. 4 is an illustration of an example package and printed circuit board architecture including an in-package temperature sensor, adapted according to one embodiment.

FIG. 5 is an illustration of an example package and printed circuit board architecture including an in-package temperature sensor, adapted according to one embodiment.

FIG. 6 is an illustration of an example package and printed circuit board architecture including an in-package temperature sensor, adapted according to one embodiment.

FIG. 7 is an illustration of a flow diagram of an example method of thermal mitigation.

### DETAILED DESCRIPTION

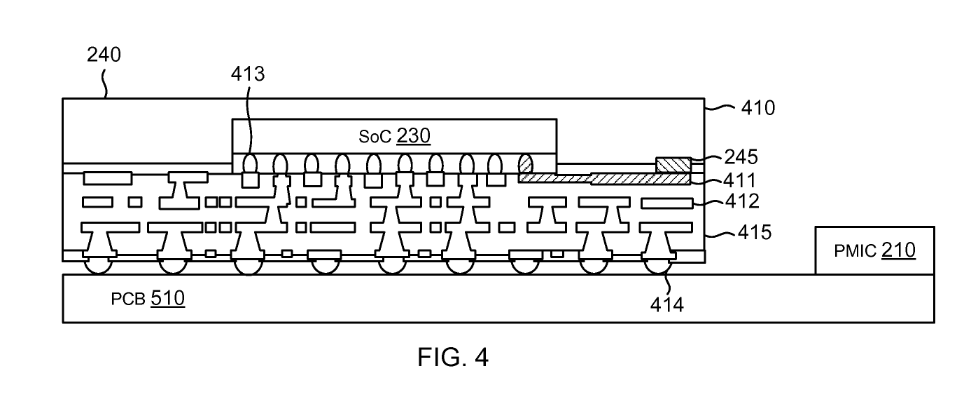

Various embodiments include systems and methods to utilize a temperature reading from off-chip and in-package to better estimate the device skin temperature. In one embodiment, a package includes an SOC that is physically disposed within the package. The package itself includes a substrate which contacts bumps on the SOC. The SOC bumps provide electrical communication with the processing circuits within the SOC. The bumps on the SOC are in electrical communication with metal layers and vias of the package, and the package includes solder balls that are configured to be in electrical communication with traces on a printed circuit board. The substrate itself includes alternating layers of metal and dielectric material, where the metal layers are connected to each other using vias. The package also includes adhesive materials to mechanically and physically attach the SOC within the structure of the package. Examples of packages are shown in more detail with respect to FIGS. 4-6.

Various embodiments place at least one temperature sensor within the package but not in direct, physical contact with the chip. In many mobile device designs, it is expected that the SOC will produce most of the internal heat. In this example, the SOC produces heat, and that heat is dissipated throughout the package. Accordingly, the temperature sensor is exposed to the heat of the SOC, but that heat is dissipated by the materials that separate the SOC from the temperature sensor. For instance, the temperature sensed by the temperature sensor is affected by the respective thermal conductivities of the constituent physical parts of the package, such as plastic molding, solder resist, conductive wire, and dielectric material.

Accordingly, while the temperature of the SOC may reach for instance 80° C.-100° C., the temperature experienced by the temperature sensor is expected to be somewhat lower than that. Furthermore, because the materials of the package provide for heat dissipation before that heat reaches the temperature sensor, the temperature sensor is expected to provide temperature readings that are more closely aligned with that of the device skin than would temperature readings acquired from the SOC itself.

Of course, the temperature sensor may be placed at any appropriate part of the package while not directly touching the SOC. Examples include the temperature sensor being placed within the dielectric material of the package substrate, the temperature sensor being placed underneath the substrate and next to conductive balls on the underside of the package, and the temperature sensor being placed on top of the substrate. The embodiments may use any appropriate temperature sensor, such as a thermistor that changes its resistance with temperature.

The process described above may be embodied as computer executable code that is read and executed by a kernel process of the processor. In another embodiment, the process may be embodied as a hardware process built in to the processor. However, in many embodiments, thermal changes at the skin of the device and at the SOC change on the order of seconds or minutes, so that software is generally fast-acting enough.

An example method embodiment may be performed by a software kernel of the SOC that is tasked with thermal mitigation. The SOC is in electrical communication with the temperature sensor and continually measures temperature using the temperature sensor. For example, if the temperature sensor is a thermistor, the SOC may apply a voltage across the thermistor and measure resistance changes by translating electrical current or voltage measurements into digital signals that can be read by the thermal mitigation process of the software kernel. When the thermal mitigation process detects that the sensed temperature is above a threshold, the thermal mitigation process may decrease the frequency of operation of the SOC (or of a component of the SOC), thereby generating less heat within the package.

The relationship of device skin temperature to in-package temperature is dependent upon the materials used in the package and the materials and design of the mobile device. The relationship may be determined through experimentation and/or knowledge of the device design. For instance, it may be expected that in-package temperature is approximately 10° C. higher than device skin temperature, so that the temperature threshold may be set at 50° C., which is 10° C. higher than the uncomfortable device skin temperature of 40° C. Of course, lowering a frequency of operation or other operating parameter of the SOC may be temporary, so that the process may return the operating frequency to a higher frequency after it detects lower temperatures.

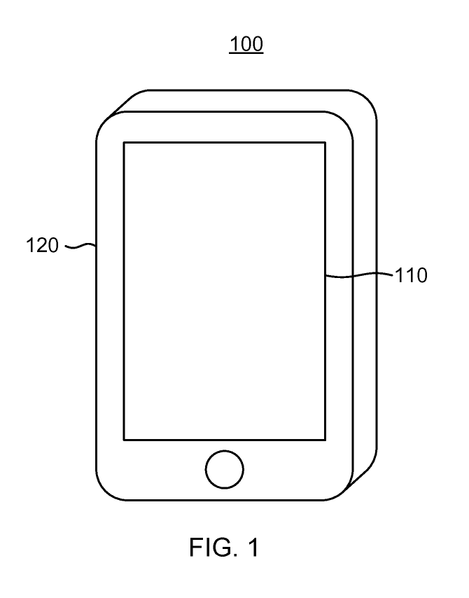

FIG. 1 is a simplified diagram illustrating an example computing device 100 in which various embodiments may be implemented. In the example of FIG. 1, computing device 100 is shown as a smart phone. However, the scope of embodiments is not limited to a smart phone, as other embodiments may include a tablet computer, a laptop computer, or other appropriate device. In fact, the scope of embodiments includes any particular computing device, whether mobile or not. Embodiments including battery-powered devices, such as tablet computers and smart phones may benefit from the concepts disclosed herein. Specifically, the concepts described herein provide techniques to reduce heat that is dissipated outside of computing device 100, thereby providing comfort for a human user and conserving battery power.

As shown in FIG. 1, computing device 100 includes an outer surface or skin 120, which may be expected to come into contact with hands or other parts of the body of a human user. The outside surface 120 includes, e.g., metal surfaces and plastic surfaces and the surfaces that make up display unit 110. In one example, display unit 110 is a capacitive liquid crystal display (LCD) touchscreen, so that the surface of display unit 110 is either glass or plastic-coated glass. The outside surface 120 therefore includes the various external surfaces such as the display unit 110 and the other parts of the external housing. Although not shown in the vantage point of FIG. 1, the back side of computing device 100 includes another part of the outer surface of the device, and specifically another part of the exterior housing, which may be arranged in a plane parallel to a plane of display unit 110.

FIG. 1 does not show a computer processor, but it is understood that a computer processor is included within computing device 100. In one example, the computer processor is implemented in a system on chip (SOC) within a package, and the package is mounted to a printed circuit board and disposed within the physical housing. In conventional smart phones, the package including the processor is mounted in a plane parallel to a plane of the display surface and a plane of the back surface. Examples of packages and printed circuit boards are discussed in more detail with respect to FIGS. 4-6.

As a computer processor operates, it produces heat, which dissipates throughout the physical structure of computing device 100. Depending on the specific thermal properties of computing device 100, heat from the operation of the processor may reach uncomfortable or near-uncomfortable temperatures on the outside surface 120 of computing device 100. The computer processor within computing device 100 provides functionality to control the heat felt on the outside surface of the computing device 100 by measuring temperature readings at one or more temperature sensors and adjusting a frequency and/or voltage of the processor if appropriate.

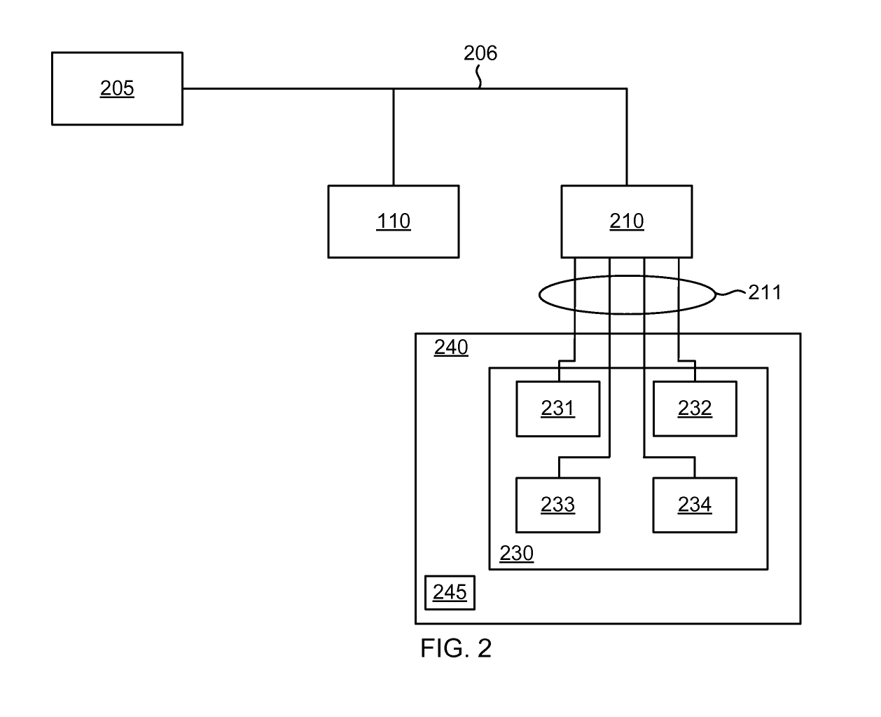

FIG. 2 is an architectural diagram of an example physical layout of the internal functional components of computing device 100 of FIG. 1, according to one embodiment. FIG. 2 is intended to be illustrative, and it omits some features for ease of illustration.

Battery 205, power management integrated circuit 210, and SOC 230 are disposed within the computing device 100 so that they are enclosed within the physical housing of the computing device 100 as indicated by exterior surface 120. Furthermore, SOC 230 is included within package 240. Battery 205, power management integrated circuit (PMIC) 210, and SOC 230 are also in thermal contact with the physical housing so that the heat generated by those items is conducted to the exterior surface 120 of the device 100. Heat generated by SOC 230 is conducted to the exterior surface 120 of the device 100 through package 240. Package 240 further includes thermal sensor 245.

Computing device 100 includes battery 205, which may be any appropriate battery now known or later developed. For instance, battery 205 may include a lithium-ion battery or other power source. Battery 205 is coupled to battery rail 206, which distributes power from the battery 205. Battery rail 206 is coupled to device display 110 and to PMIC 210. In some embodiments, the power from battery rail 206 may be regulated or otherwise conditioned before being provided to display 110, however for ease of illustration, battery rail 206 in this example is provided directly to display 110.

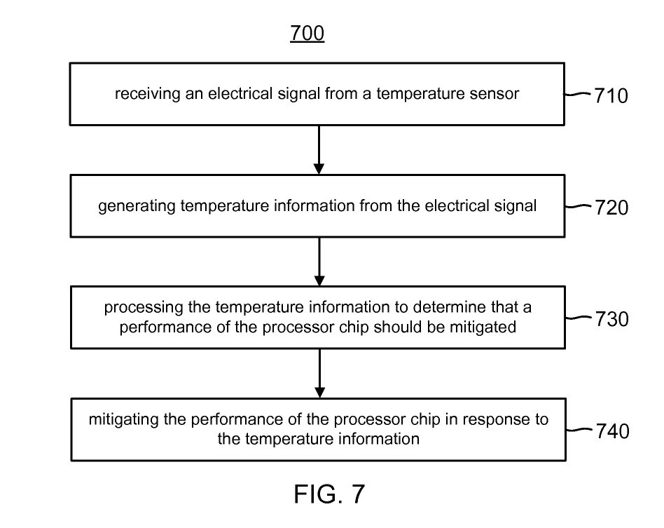

PMIC 210 receives power from battery rail 206 and regulates the voltage to provide an output voltage that is usable by SOC 230. SOC 230 has four cores, 231-234. Examples of cores include a central processing unit (CPU), a graphics processing unit (GPU), a modem, and the like. Although not shown in FIG. 2, a clocking circuit provides a clock signal with an operating frequency to each of the cores 231-234, where the clocking circuit may be controlled to increase or decrease the operating frequency. In some examples, thermal mitigation may be performed by reducing an operating frequency of the cores 231-234 by performing the algorithm of FIG. 7.

PMIC 210 provides power to SOC 230, and specifically provides power to the cores 231-234 by four separate power rails 211 in this embodiment. The scope of embodiments is not limited to any particular SOC architecture, as any appropriate number of cores and PMIC power rails may be used in a particular embodiment. For instance, other embodiments may include 16 cores, 32 cores, or other number.

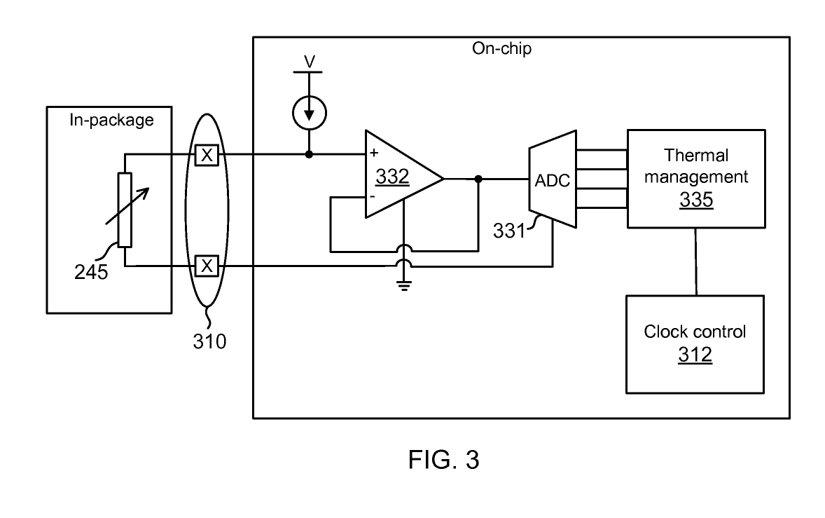

SOC 230 includes functionality to measure temperature using temperature sensor 245 and to keep an outside surface of the device within a defined temperature band by mitigating performance of SOC 230 based on temperature measurements from temperature sensor 245. An example method is shown in FIG. 7, and an example architecture is shown in FIG. 3.

FIG. 3 provides an illustration of an example system that performs the methods described herein. The system of FIG. 3 includes temperature sensor 245, which in this embodiment is shown as a thermistor. A thermistor changes its resistance according to temperature, and the relationship between temperature and resistance is usually non-linear. However, a given thermistor has a known temperature-resistance relationship. Temperature sensor 245 is shown in this embodiment in an area labeled “in-package.” Examples of in-package configurations are shown in more detail with respect to FIGS. 4-6.

Temperature sensor 245 is in electrical communication with on-chip circuitry through use of conductive contacts 310. On-chip circuitry in this example includes circuits and logic that are implemented within SOC 230 (FIG. 2). The on-chip circuitry includes operational amplifier 332, which has a non-inverting input (+) and an inverting input (−). The non-inverting input is in communication with temperature sensor 245. Operational amplifier 332 includes negative feedback, so that the output terminal is coupled to the inverting input. This arrangement smooths out the voltage reading. Voltage at the non-inverting input is indicative of a temperature experienced by temperature sensor 245. Therefore, the output terminal of operational amplifier 332 provides an analog signal that is indicative of the temperature experienced by sensor 245.

The analog output signal from operational amplifier 332 is received by analog to digital converter (ADC) 331, and ADC 331 produces a digital signal indicative of the temperature information received from operational amplifier 332. ADC 331 passes the digital signal to thermal management unit 335 for further processing. Thermal management unit 335 in one example includes hardware logic to provide thermal management services to SOC 230.

In another embodiment, thermal management unit 335 represents thermal management processes that are provided by a software kernel of the SOC 230. For instance, SOC 230 may include a software kernel, which operates when SOC 230 is powered up and receiving a clock signal. Thermal management unit 335 may in that instance include a software process that is built into kernel 330 to perform the method described with respect to FIG. 7. However, either hardware or software or a combination thereof may perform the processes described herein to provide thermal management.

Thermal management unit 335 receives the digital signal from ADC 331, and the digital signal includes data indicative of a temperature measured by sensor 245. Thermal management unit 335 includes at least one programmed temperature threshold that corresponds to a package temperature associated with an undesirable rise in skin temperature. Thermal management unit 335 receives the digital signal from ADC 331 and compares temperature information of that digital signal to the programmed temperature threshold. If the temperature is below the temperature threshold, then thermal management unit 335 may simply continue monitoring on a periodic basis or at other appropriate times. However, thermal management unit 335 may reduce an operating parameter of SOC 230 in response to determining that the temperature indicated by the digital signal has exceeded the threshold. Examples of reducing an operating parameter include reducing a voltage and/or a frequency of operation of SOC 230. The example of FIG. 3 assumes that the process includes at least reducing an operating frequency of SOC 230.

Thermal management unit 335 may reduce the clock frequencies provided to the cores or increase the clock frequencies provided to the cores by sending commands to clock control unit 312. Clock control unit 312 may be physically a part of SOC 230 or separate therefrom, as the scope of embodiments is not limited to any particular clocking architecture. Clock control unit 312 may control for instance a phase locked loop (PLL) or other appropriate circuit that provides a periodic clock signal in order to raise or lower the operating frequency of one or more of the cores 231-234.

In one example, when thermal management circuit 335 compares the temperature to the temperature threshold then determines that it is appropriate to lower a frequency of operation, thermal management unit 335 sends a control signal to clock control unit 312 instructing clock control unit 312 to reduce the frequency of operation. Furthermore, thermal management circuit 335 may continue to monitor the temperature data from the digital signal and compare it to either the same or a different threshold, and when the temperature drops below either the same or a different threshold, thermal management circuit 335 may increase the frequency of operation by sending another control signal to clock control unit 312.

The temperature threshold (or thresholds) that are used by thermal management unit 335 may depend upon the particular thermal conductive properties of a given device. A given device, such as computing device 100 of FIG. 1, is made of various physical materials that cause the device to have particular thermal conductive properties. For instance, some computing devices may include a specially designed heat spreader that is internal to the housing and placed between an inside surface of the housing and the computer processor within the device. A well-functioning heat spreader may keep the heat that is generated by the SOC from being concentrated at one area of the housing, thereby maintaining a more uniform heat profile around the surface of the computing device. Since the heat is spread to more surface area, the heat may be removed by ambient air more efficiently, thereby allowing more heat generation by the SOC before thermal mitigation becomes appropriate.

On the other hand, some computing devices may have different levels of heat spreading, such that heat from the SOC is conducted from the SOC less evenly. Therefore, the heat is concentrated to specific areas of the skin of the device. Such areas may become heated more quickly, and the heat may be removed from the surface by ambient air less efficiently since less surface area is heated. Such a computing device may utilize thermal mitigation algorithms more often in order to avoid heating those specific areas beyond a level that is comfortable for a human user.

Each model of computing device has its own thermal properties. Therefore, a thermal algorithm that is designed specifically for a particular model of computing device may not work well for different models of computing devices. In the example above, thermal management unit 335 compares temperature data of the digital signal to a programmed threshold. The threshold corresponds to a sensed temperature where it is expected that the device skin temperature has reached an uncomfortable level or will reach an uncomfortable level within seconds or minutes unless mitigation is performed. Of course, an uncomfortable level for the device skin may be set by engineers to be 40° C.-45° C. or other appropriate temperature level. Furthermore, the threshold may be different for different device models and types. As explained above, the thermal conductive properties of a particular device depends upon the physical makeup and arrangement of the materials of the device.

In some embodiments, it is assumed that the temperature sensed by the temperature sensor in the package increases over time in a curve that is very similar to a curve for the device skin temperature. In fact, for some devices during normal operation after several minutes, a temperature curve for the package temperature follows a temperature curve for the device skin temperature but with a constant offset (e.g., 10° C.). Therefore, in some embodiments, thermal management unit 335 is configured so that the threshold corresponds to that constant offset. In one example if 40° C. is considered an uncomfortable device skin temperature, and the offset is 10° C., the threshold is set at 50° C. Of course, these numbers are examples only, and particular uncomfortable device skin temperatures and offsets are device-dependent.

It is generally expected that the temperature that is sensed by the in-package sensor will be higher than a device skin temperature but lower than a temperature of the SOC, at least during normal operation. Furthermore, the SOC may experience more rapid changes in temperature than does the device skin. A temperature sensor in the package but separate from the chip would be expected to experience temperature changes more slowly than those experienced by the SOC, so that the material of the package acts as a low pass filter with respect to frequency of temperature changes. Of course, it is also expected that temperature changes of the temperature sensor in the package would be more rapid than those experienced by the device skin itself. In some instances, thermal management unit 335 may take into account the speed at which temperature changes at the temperature sensor versus the device skin.

In some embodiments, the temperature threshold used by thermal management unit 335 may be a design parameter that is known by simulation during the design phase of the device. In other embodiments, the temperature threshold may be determined through experimentation with a physical embodiment of the device. For instance, a computer-aided design program may be used by a designer to determine the heat conductive properties of the device as the device is being designed. Additionally or alternatively, a designer may take temperature readings of the skin of the device as well as readings from the in-package temperature sensor in a controlled environment in order to determine appropriate values for one or more thresholds. Such design and/or testing may be performed by a designer or manufacturer of the device.

In one example use case, a manufacturer or designer of a computing device determines one or more temperature thresholds. The designer or manufacturer then saves that information into memory of SOC 230 for use by thermal management unit 335. This process is performed before delivering finished units to consumers, so that the finished product includes robust thermal mitigation functionality built into it.

FIGS. 4-6 are examples of systems employing in-package temperature sensors, according to various embodiments. A given package and PCB architecture shown in FIGS. 4-6 may be disposed within the device 100 (FIG. 1) so that it is enclosed at least partly by the outer housing. The long dimension (in this example horizontal) may correspond to the height dimension of device 100 of FIG. 1, so that PCB 510 may be placed parallel to display 110 and to the back surface of the device 100.

Beginning with FIG. 4, the system includes SOC 230 disposed within package 240. Electrical connection is made between SOC 230 and the rest of package 240 by use of conductive bumps 413. Package 240 is disposed upon printed circuit board (PCB) 510, and electrical connection is made between package 240 and PCB 510 through use of solder balls 414. Power management integrated circuit (PMIC) 210 provides power to SOC 230 by metal traces (not shown) of PCB 510, one or more solder balls 414, one or more metal layers 412, and one or more conductive bumps 413.

Package 240 includes multiple layers in this example. The topmost layer is a black plastic molding 410, which operates to shield SOC 230 from the environment and to mechanically secure SOC 230 to package 240. The substrate portion of package 240 includes alternating layers of dielectric material 415 and metal layers 412 connected by vias. The examples of FIGS. 4-6 are simplified for ease of illustration, and it is understood that a given package may include more and different layers, such as various adhesives and masks. The scope of embodiments is not limited to any particular package architecture or materials.

Further in the example of FIG. 4, temperature sensor 245 is disposed within the package such that it is on top of the substrate portion and below plastic molding 410. Temperature sensor 245 is in electrical communication with SOC 230 by use of conductive path 411, which includes metal from one or more of the metal layers of the substrate. In the example of FIG. 4, temperature sensor 245 is physically separate from SOC 230, and it is in indirect thermal contact with SOC 230. Heat produced by SOC 230 is conducted through the materials of package 240 and sensed by temperature sensor 245.

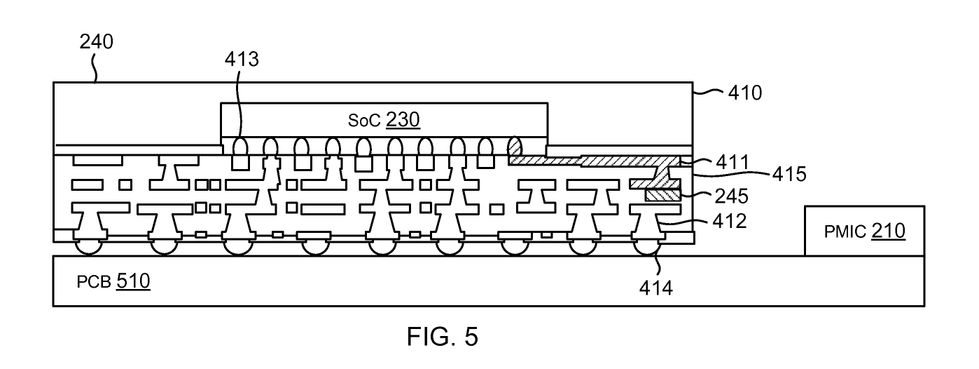

Moving to the example of FIG. 5, temperature sensor 245 is disposed within the layers of the substrate. As mentioned above, the substrate portion of package 240 includes alternating layers of metal 412 and dielectric material 415. Sensor 245 is disposed within the substrate such that it is below the topmost metal and dielectric layers and above the bottommost dielectric and metal layers. Temperature sensor 245 is in electrical communication with SOC 230 by use of conductive path 411, which utilizes one or more metal layers and one or more vias of the package substrate.

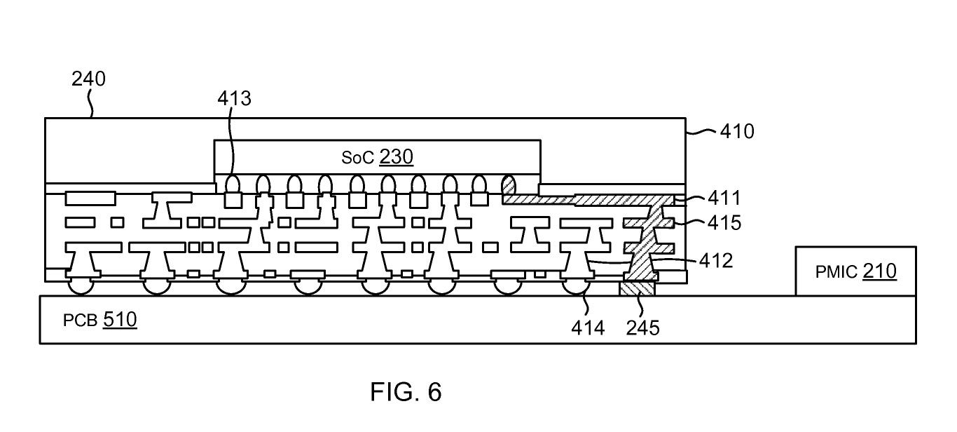

Moving to FIG. 6, temperature sensor 245 is placed on the bottom of the substrate at the same layer as solder balls 414. Specifically, temperature sensor 245 is placed below the bottommost metal layer and the bottommost dielectric layer of the package substrate. Once again, temperature sensor 245 is in electrical communication with SOC 230 by use of conductive path 411, which utilizes one or more metal layers and one or more vias of the package substrate.

The embodiments of FIGS. 4-6 demonstrate that designers may place temperature sensor 245 physically separate from SOC 230 but within the package 240 itself. As a result, heat conduction from SOC 230 is affected by the physical materials of the package 240. The physical materials of the package 240 act as a heat spreader and low pass filter, so the temperature sensor 245 senses less rapid temperature changes than would be experienced at SOC 230, and it is generally expected that during normal operation temperature sensor 245 would measure lower temperatures than would be experienced by an on-chip temperature sensor.

A flow diagram of an example method 700 of providing thermal mitigation is illustrated in FIG. 7. In one example, method 700 is performed by thermal management unit 335, such as described above with respect to FIG. 3. Method 700 assumes that the temperature threshold is already known for the particular device. As the device operates during normal use, thermal management unit 335 performs the actions of method 700. Therefore, as a human user leaves the device idle, makes phone calls, sends text messages, watches videos, and the like, thermal management unit 335 continually performs the actions 700 to ensure that the device skin temperature does not reach a pre-defined uncomfortable level. It is noted in this example that a reading of temperature is taken at a temperature sensor that is physically separate from the SOC but is in-package along with the SOC, and the thermal mitigation processing (e.g., actions 730 and 740) is performed by logic at the SOC itself.

At action 710, the system receives an electrical signal from a temperature sensor. For example, in the embodiment of FIG. 3, on-chip circuitry receives an electrical signal from a thermistor, shown as temperature sensor 245. The voltage or current at the thermistor is indicative of a resistance of the thermistor and, therefore, the temperature of the thermistor. The scope of embodiments is not limited to any particular temperature sensor. For instance, other embodiments may employ a temperature diode, a digital thermometer, a thermocouple, or other appropriate temperature sensor.

At action 720, the system generates temperature information from the electrical signal. For instance, in the embodiment of FIG. 3, the electrical signal from the thermistor is fed to an operational amplifier and then to an ADC, where the output of the ADC is a digital signal indicative of the temperature at the temperature sensor.

At action 730, the system processes the temperature information to determine that a performance of the processor chip should be mitigated. For instance, in the example of FIG. 3, thermal management unit 335 compares the temperature information against a programmed temperature threshold. The value of the temperature threshold may be any appropriate value, and it represents temperature of the temperature sensor that is associated with temperature limit of the device skin, such as a temperature that is known to be unsafe or uncomfortable. The value of the temperature threshold will depend on the heat conduction properties of the particular device. For instance, a device with a heat spreading layer built into it may be assigned a higher temperature threshold than a device that allows a more rapid heat transfer from the SOC to the skin. In some scenarios, the temperature threshold may be assigned to a device based upon experimentation and/or known heat transfer properties of the design. As noted above, the temperature threshold may be saved to memory in the processor of the device and accessed by thermal management unit 335 as it performs method 700.

In alternative embodiment, action 730 may include estimating a device skin temperature using the temperature information. For instance, if there is a known offset (e.g., 10° C.) between the in-package temperature and a skin temperature of the device, the offset may be used to estimate the skin temperature of the device from the temperature information (e.g., by subtracting 10° C. from the in-package temperature). In such an embodiment, the temperature threshold may correspond to a limit of the device skin (e.g., 40° C.). In such an instance, action 730 may include comparing the estimated skin temperature to the skin temperature threshold and determining to mitigate the temperature based on that comparison.

At action 740, system mitigates the performance of the processor chip in response to the temperature information. For instance, in the example of FIG. 3, thermal management unit 335 compares the temperature information to the programmed threshold. If the temperature information indicates that the temperature of the temperature sensor is greater than the threshold, then the thermal management unit 335 may reduce an operating parameter of the processor chip. An example of a processor chip is SOC 230 of FIG. 2, although the principles described herein may be applied to any appropriate computer processor.

In one example, the thermal management unit 335 reduces an operating frequency of one or more cores in the SOC, thereby reducing power consumption. However, action 740 may include any appropriate thermal mitigation technique, such as putting cores in an idle state. For instance, in the example of FIG. 3, thermal management unit 335 may send commands to clock control unit 312 to reduce the clock frequency or gate the clock frequency altogether. In fact, reduction of any operating parameter, such as frequency or voltage, is within the scope of embodiments. The process continues to operate as the SOC operates, continually measuring the power consumption and taking appropriate mitigation steps according to the algorithm.

The scope of embodiments is not limited to the specific method shown in FIG. 7. Other embodiments may add, omit, rearrange, or modify one or more actions. For instance, method 700 may also include functionality to return the clock frequency to a previous level or otherwise to increase the clock frequency when thermal mitigation is no longer desired, such as after determining that the measured temperature has decreased beyond the same or a different threshold. Also, various embodiments may include taking multiple temperature readings from various temperature sensors spread throughout the package and perhaps the SOC itself. In fact, method 700 does not exclude the use of on-chip temperature readings for other processes.

Various embodiments may provide one or more advantages over conventional solutions. For instance, it may be difficult to capture a temperature reading directly from the skin of a computing device, especially for more compact and mobile computing devices such as phones and tablets. Nevertheless, skin temperature can be very relevant to a user's perception of comfort. Some conventional solutions use temperature readings gathered from sensors on the processor and base thermal mitigation decisions on that temperature reading. But temperature readings gathered from thermal sensors on the processor may not provide an accurate indication of skin temperature, thereby causing intervention of a thermal mitigation process too early or too often and sacrificing performance of the system.

By contrast, the systems described herein provide thermal mitigation using temperature readings gathered from one or more temperature sensors physically separate from the chip but nevertheless in the same package as the chip. The physical materials of the package spread the heat produced by the chip and act as a low pass filter, so that a temperature reading from an in-package temperature sensor more closely matches a temperature curve of the device skin as compared to a temperature sensor on-chip. Some embodiments described herein may improve the operation of a processor chip by allowing for more accurate thermal management, thereby providing comfort and safety for human users.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method comprising:
receiving an electrical signal from a temperature sensor, wherein the temperature sensor is disposed within a package including a processor chip, further wherein the temperature sensor is thermally separated from the processor chip by materials within the package;
generating temperature information from the electrical signal;
processing the temperature information to determine that a performance of the processor chip should be mitigated; and
mitigating the performance of the processor chip in response to the temperature information, wherein processing the temperature information and mitigating the performance of the processor are performed by the processor chip.

2. The method of claim 1, wherein generating temperature information comprises:
generating digital signals from the received electrical signal from the temperature sensor, the digital signals being indicative of a temperature experienced by the temperature sensor.

3. The method of claim 1, wherein the electrical signal indicates a voltage associated with the temperature sensor.

4. The method of claim 1, wherein the temperature sensor comprises a thermistor.

5. The method of claim 1, wherein the temperature sensor is separated from the processor chip by a layer of dielectric in a substrate of the package.

6. The method of claim 1, wherein processing the temperature information comprises:
comparing the temperature information to a programmed threshold temperature.

7. The method of claim 1, wherein the method is performed by a software kernel of the processor chip.

8. The method of claim 1, wherein the package including the processor chip is incorporated into a handheld computing device, and wherein processing the temperature information comprises:
comparing the temperature information to a handheld computing device skin temperature limit.

9. The method of claim 1, wherein mitigating the performance of the processor chip comprises:
reducing an operating frequency of the processor chip.

10. The method of claim 9, further comprising:
increasing the operating frequency of the processor chip after determining that the temperature information indicates a temperature reduction of the package.

11. A system comprising:
a computer processor configured to execute machine-readable instructions and to consume power from a system battery, the computer processor being disposed within a package having a dielectric substrate and providing electrical communication between the computer processor and a plurality of electrical components of the system;
a physical housing enclosing at least a portion of the system, the package being disposed within the system so that it is enclosed within the physical housing, the computer processor further being in thermal contact with the physical housing through the package; and
a temperature measuring device disposed within the package and thermally separated from the computer processor by materials of the package, the temperature measuring device being in electrical communication with the computer processor, the computer processor configured to perform the following operation:
receive electrical signals from the temperature measuring device;
in response to the electrical signals from the temperature measuring device, determine that a thermal mitigation operation should be undertaken; and
reduce an operating parameter of the computer processor in accordance with the thermal mitigation operation.

12. The system of claim 11, wherein the system is at least one of a smart phone and a tablet computer.

13. The system of claim 11, wherein the operating parameter of the computer processor comprises an operating frequency.

14. The system of claim 11, wherein the computer processor is further configured to perform the following operation:
increase the operating parameter of the computer processor in response to determining that the temperature of the temperature measuring device has decreased.

15. The system of claim 11, wherein the computer processor is implemented in a system on chip (SOC) within the package, wherein the package is mounted to a printed circuit board and disposed within the physical housing.

16. The system of claim 11, wherein the electrical signals are indicative of a temperature experienced by the temperature measuring device.

17. The system of claim 11, wherein the temperature measuring device is disposed on a top layer of a substrate of the package.

18. The system of claim 11, wherein the temperature measuring device is disposed between two metal layers of a substrate of the package.

19. The system of claim 11, where the temperature measuring device is disposed at a bottom layer of a substrate of the package.

20. A system comprising:
means for providing information indicating a temperature of a chip package within the system;
means for comparing the temperature of the chip package to a temperature threshold and for generating a control signal in response to determining that the temperature of the chip package exceeds the temperature threshold;
means for reducing an operating parameter of the means for comparing in response to the control signal; and
a physical housing enclosing at least the means for comparing and the means for providing, the means for comparing further being in thermal contact with the means for providing through a substrate of the chip package.

21. The system of claim 20, wherein the means for providing information comprises a thermistor.

22. The system of claim 20, wherein the means for reducing the operating parameter comprises a clock control circuit.

23. The system of claim 20, wherein the means for comparing the temperature of the chip package comprises a system on chip (SOC) with a thermal mitigation algorithm.

24. The system of claim 20, further comprising means for increasing the operating parameter of the means for comparing in response to determining that the temperature of the chip package has decreased.

25. A computer program product having a computer readable medium tangibly recording computer program logic for mitigating temperature of a chip, the computer program product comprising:
code to generate temperature information from a sensor within a chip package and at a location physically separate from the chip within the chip package;
code to compare the temperature information to a programmed temperature threshold, wherein comparing the temperature information to the programmed temperature threshold is performed by the chip;
code to reduce an operating parameter of the chip in response to comparing the temperature information to the programmed temperature threshold; and
code to increase the operating parameter of the chip in response to determining that the temperature information indicates a reduction in temperature.

26. The computer program product of claim 25, wherein the code to reduce the operating parameter of the chip comprises code to reduce an operating frequency of the chip.

27. The computer program product of claim 25, wherein the code to reduce the operating parameter of the chip comprises code to reduce an operating voltage of the chip.

28. The computer program product of claim 25, wherein the temperature threshold corresponds to a temperature limit for an exterior surface of a physical housing of a computing device in which the chip package is disposed.

29. The computer program product of claim 25, wherein the sensor comprises a thermistor.

30. The computer program product of claim 25, wherein the programmed temperature threshold is stored to a memory of the chip.
